(19) United States
(12) Patent Application Publication
(10) Pub. No.: US 2003/0070407 A1
(43) Pub. Date: Apr. 17, 2003

(54) Self-propelled walk-behind string trimmer

(76) Inventors: Orville R. McDonner, Salem, IN (US); Richard T. Ruebusch, New Albany, IN (US); Kevin L. Johnson, Douglas, GA (US)

Correspondence Address: BAKER & DANIELS, 111 E. WAYNE STREET, SUITE 800, FORT WAYNE, IN, 46802

(21) Appl. No.: 10/238,187

(22) Filed: Sep. 10, 2002

Related U.S. Application Data
(60) Provisional application No. 60/325,379, filed on Sep. 27, 2001.

(51) Int. Cl. A01D 34/00

(52) U.S. Cl. 56/12.7

(57) ABSTRACT

A walk-behind string trimmer including a frame, an engine mounted on the frame, a rotary cutter carried by the frame and selectively engaged with the engine, a pair of ground engaging wheels, a transmission mounted by the frame and engaged with the engine, and a steering mechanism. The transmission has an output shaft and the steering mechanism includes a ratchet member driven by the output shaft, wherein the ground engaging wheels are selectively drivingly coupled to the transmission through the ratchet member.

### BACKGROUND OF THE INVENTION

1. Field of the Invention

The present invention relates to string trimmers used in both residential and commercial lawn care, specifically walk-behind string trimmers.

2. Description of the Related Art

In addition to the use of lawn mowers to cut the lawn, many homeowners and commercial lawn care services also use gasoline engine or electric motor-powered string trimmers to cut any grass which the mower can not reach, such as near flower gardens, around trees, around decks or porches, and other such areas. String trimmers are also used to trim overgrown areas which would clog and stall a lawn mower. Prior art string trimmers were essentially of two types: hand-held, or ones in which the operator would carry the trimmer to operate the device, and walk-behind, which resemble walk-behind lawn mowers in that the operator pushes the trimmers around to operate the trimmer. Such walk-behind trimmers are disclosed in U.S. Pat. No. 5,862,655, assigned to Garden Way Incorporated of Troy, N.Y., and U.S. Pat. No. 4,703,613, assigned to Country Home Products, Incorporated of Ferrisburg, Vt., the disclosures of which are expressly incorporated herein by reference.

With either the hand-held or the walk-behind string trimmers, an operator of smaller stature has difficulty in operating the trimmers. The hand-held string trimmers prove to be heavy and unwieldy for a smaller person or potentially unwieldy for any operator of any stature. The walk-behind string trimmers may still prove to be unwieldy and difficult to operate for a person having insufficient strength or weight to push the trimmer around to trim all areas. While some manufacturers have made walk-behind trimmers easier to manage, the walk-behind trimmers typically still require force to push the trimmer, causing a need for a reduction in weight of the trimmer to facilitate movement of the trimmer by any person. However, the decrease in weight of the walk-behind mowers has come at a loss of engine horsepower and decrease in engine size, thereby potentially preventing the trimmer from cutting the grass in an effective manner.

A response to the need for enabling movement of a trimmer has included a prior art trimmer (FIG. 1) which utilized a France Reducteur transmission and a pair of chain and sprocket mechanisms to propel the trimmer to assist the operator in pushing the trimmer around. Such a string trimmer was shown at GAFA in Köln, Germany in September of 2000. Since the trimmer is self-propelled, the weight of the trimmer is not an issue, thereby allowing for a larger engine to be used yet still allowing the operator to easily move the trimmer. While this trimmer does attempt to assist the operator by making the trimmer easier to move by being self-propelled, the trimmer is still difficult to steer. This trimmer utilizes a transmission manufactured by France Reducteur, that transmission having a solid output shaft extending therethrough, the ends of which were supported by bearings affixed to the trimmer body. Near each end of the output shaft a sprocket was affixed thereto. Chains connected these sprockets to two mating, larger diameter sprockets affixed to a solid axle extending through the trimmer body and supported by bearings attached to the trimmer body. Rotatably fixed directly to each end of the solid axle was a ground-engaging drive wheel, these two drive wheels incapable of being rotated relative to each other. There is no apparatus for allowing the wheels to rotate relative to one another to facilitate easy steering of the trimmer. Thus, whenever it is desired that the trimmer be turned, the operator must push the trimmer through the turn with one wheel skidding along the ground.

A self-propelled, walk-behind string trimmer which is easy to steer would be highly desirable.

### SUMMARY OF THE INVENTION

The present invention overcomes the shortcomings of the prior art string trimmers by providing a self-propelled, walk-behind string trimmer which may be easily steered. The inventive string trimmer includes a transmission engaged with the engine to provide propulsion in a manner similar to that of a self-propelled walk-behind lawn mower and includes a mechanism to facilitate easy steering thereof. By including this mechanism, the string trimmer is easily maneuvered by anyone, and by being self-propelled, the trimmer does not require a reduction in engine horsepower or size.

The present invention provides a walk-behind string trimmer including a frame, an engine mounted on the frame, a rotary cutter carried by the frame and selectively engaged with the engine, a pair of ground engaging wheels, a transmission mounted by the frame and engaged with the engine, and a steering mechanism. The transmission has an output shaft and the steering mechanism includes a ratchet member driven by the output shaft, wherein the ground engaging wheels are selectively drivingly coupled to the transmission through the ratchet member.

### BRIEF DESCRIPTION OF THE DRAWINGS

The above mentioned and other features and objects of this invention will become more apparent and the invention itself will be better understood by reference to the following description of an embodiment of the invention taken in conjunction with the accompanying drawings, wherein:

FIG. 1 is a rear view of a prior art self-propelled string trimmer;

FIG. 2 is a rear view of a string trimmer in accordance with the present invention;

FIG. 3 is a bottom perspective view of the string trimmer of FIG. 2;

FIG. 4 is a schematic diagram of the inventive trimmer including the connections between the engine and the transmission;

FIG. 5 is a cross-sectional view of the wheel drive of the inventive string trimmer;

FIG. 6 is a side view of the ratchet member of FIG. 5; and

FIG. 7 is a perspective view of a portion of the ratchet member of FIG. 6.

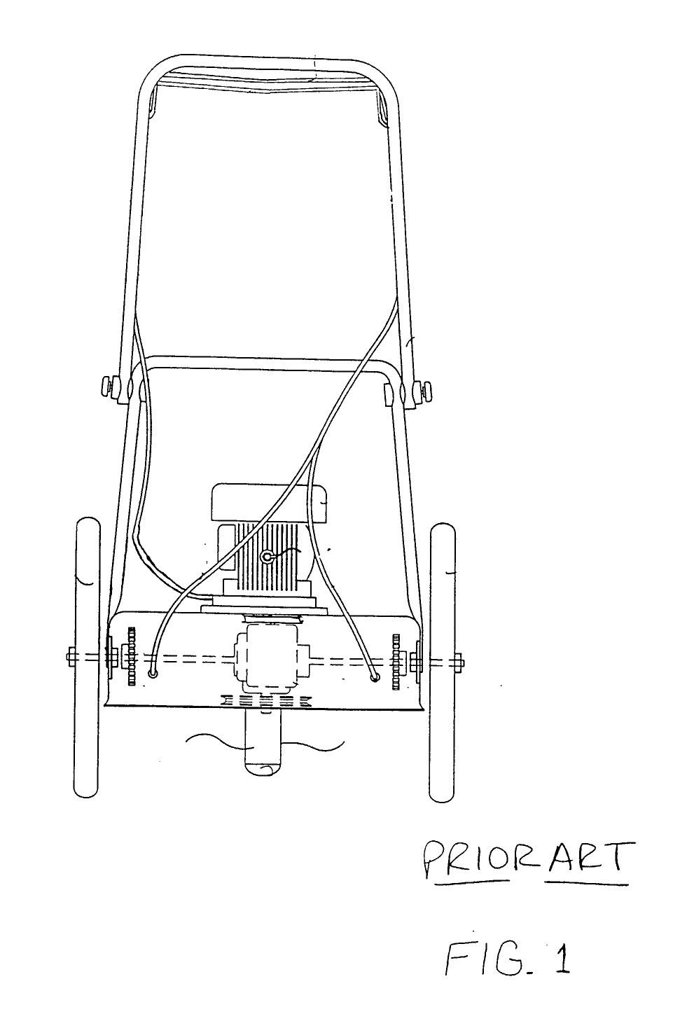

Corresponding reference characters indicate corresponding parts throughout the several views. The exemplifications set out herein illustrate an embodiment of the invention and such exemplifications are not to be construed as limiting the scope of the invention in any manner.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended.

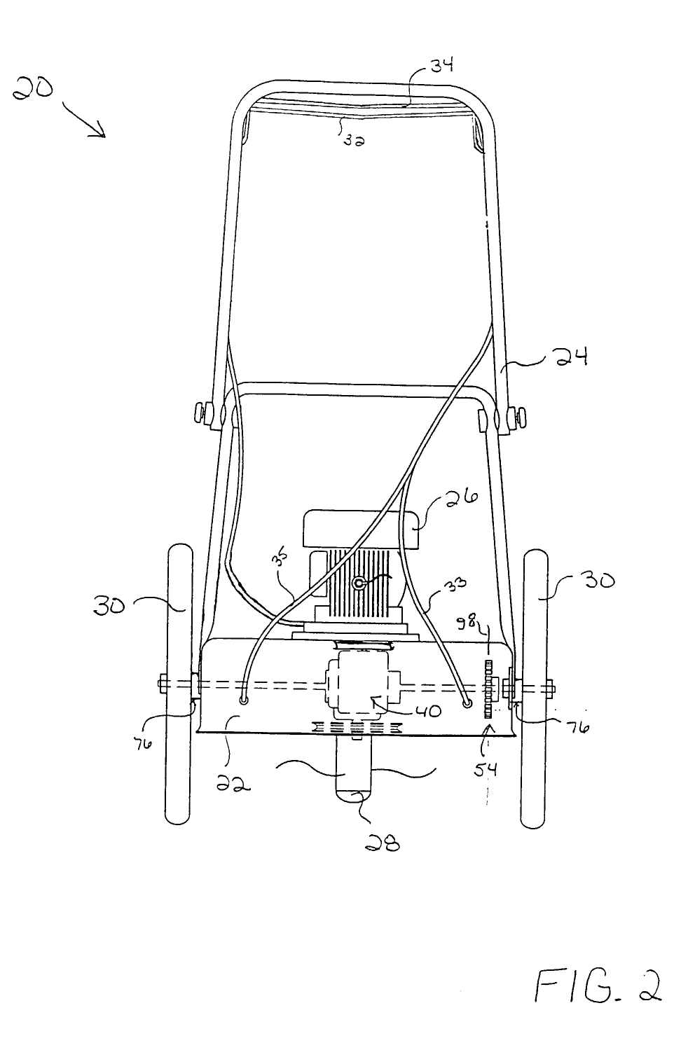

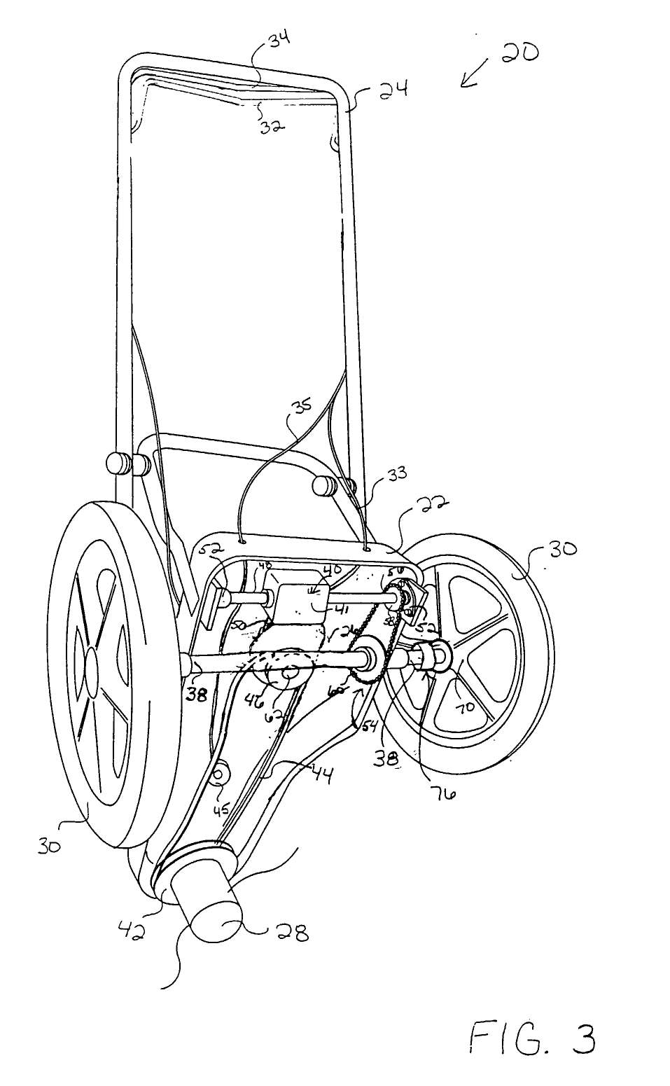

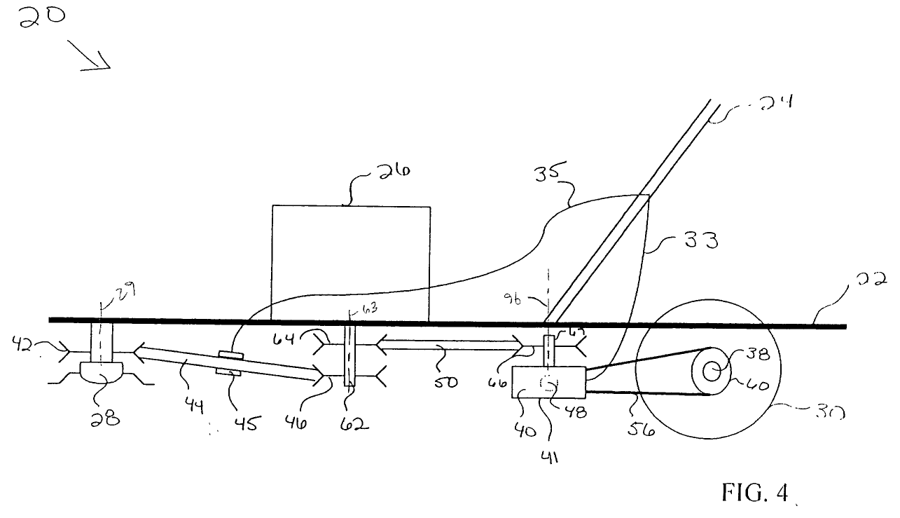

Referring to FIG. 2, a rear view of inventive string trimmer 20 is shown. Trimmer 20 includes frame 22 to which is attached vertical shaft engine 26 and multi-part handle 24; on either side of frame 22 are ground engaging wheels 30, which are attached to axle 38 (FIG. 3). Bail 32, located on handle 24, is connected to cable 33 which extends into frame 22 to link with transmission 40 to allow the operator to engage transmission 40 (FIG. 3). Also on handle 24 are bail 34 and cable 35 which may be connected to one or more belt tensioners 45 (FIGS. 3 and 4) to allow selective tensioning of trimmer drive belt 44 (FIG. 3).

Referring again to FIG. 2, output shaft 62 of engine 26 has axis of rotation 63 and is provided with first output shaft pulley 46 and second output shaft pulley 64 (FIG. 4). Trimmer drive belt 44 is reeved about first output shaft pulley 46 and engages trimmer head pulley 42, which is rotatably fixed to rotary cutter or string trimmer head 28, to provide driving engagement therebetween. As best seen in FIG. 4, rotary cutter axis of rotation 63 is substantially parallel with, and located forward of, engine output shaft 62. String trimmer head 28 is similar in structure to known trimmer heads, such as those found in previous string trimmers such as, for example, those disclosed in U.S. Pat. No. 5,577,374, the disclosure of which is expressly incorporated herein by reference. Both trimmer head pulley 42 and string trimmer head 28 are rotatably mounted to the underside of frame 22.

Within the interior space of frame 22, variable speed transmission 40 having housing 41 is provided; transmission 40 is similar to transmissions found on walk-behind lawn mowers, such as the commercially available Model 301 Transmission, available from the Peerless Division of Tecumseh Products Company or such as that disclosed in U.S. patent application Ser. No. 09/902,412, filed Jul. 10, 2001, assigned to the assignee of the present invention, the disclosure of which is expressly incorporated herein by reference. Reeved about second output shaft pulley 64 (FIG. 4) of engine 26 is transmission drive belt 50 which engages transmission pulley 66 (FIG. 4) rotatably fixed to input shaft 67 of transmission 40, which has axis of rotation 96 substantially parallel with engine output shaft axis of rotation 63. Transmission 40 is further provided with a pair of cone clutches within housing 41 which may be selectively engaged to couple output shaft 48 of transmission 40 with its respective input shaft 67 via a worm and worm gear arrangement. As an alternative, transmission drive belt 50 may be selectively tensioned through a belt tensioner to bring transmission 40 into operative engagement with engine 26.

Transmission 40 is supported at each end of its output shaft 48 by bearings 52 attached to the interior of frame 22. Although there is speed reduction provided between transmission input shaft 67 and output shaft 48 inside transmission housing 41, further speed reduction is accomplished by driving axle 38 of trimmer 20 through sprocket and chain mechanism 54. Mechanism 54 includes first, smaller diameter sprocket 58 mounted on output shaft 48, second, larger diameter sprocket 60 aligned in plane 98 with first sprocket 58 and mounted on axle 38, and chain 56 engaging the sprockets. It is to be noted that only one sprocket and chain mechanism 54 is used to drive axle 38. As such, mechanism 54, that is, plane 98, may be located on either side of the transmission housing within frame 22.

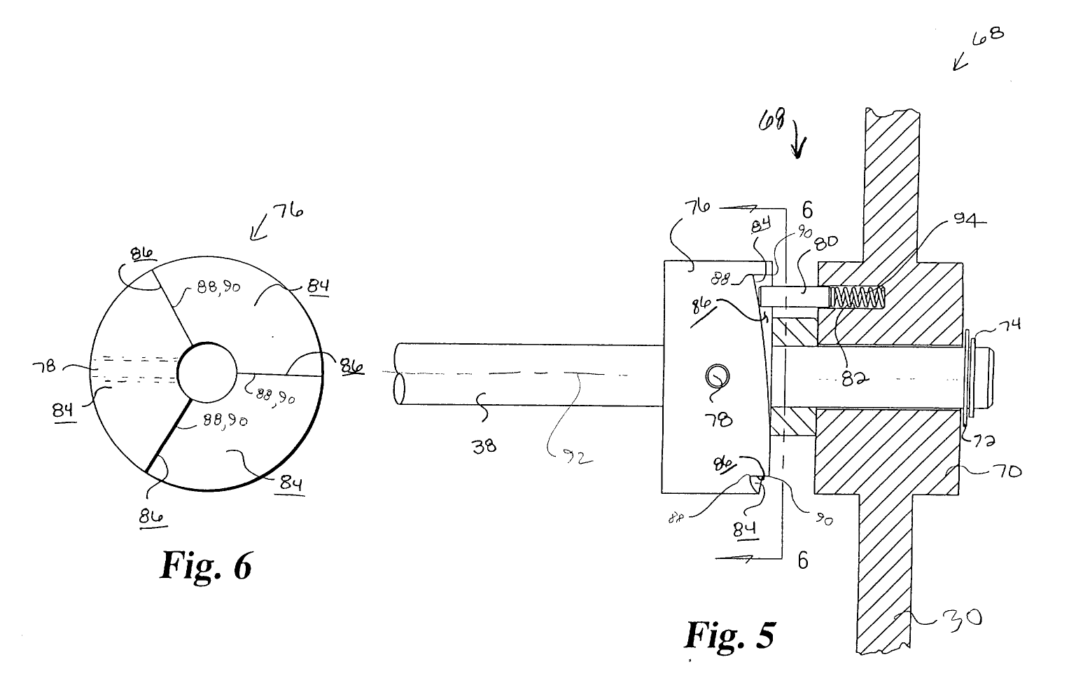

Referring now to FIG. 5, inventive trimmer 20 includes wheel drive, or steering mechanism, 68 which is used for facilitating easy steering of trimmer 20 as it is being propelled. Wheel drive 68 is placed at each end of axle 38 adjacent a ground engaging wheel 30. Each wheel drive 68 includes wheel hub 70 rotatably disposed about axle 38, and located in the center of wheel 30. Hub 70 is composed of a plastic material and is prevented from moving axially outward along axle 38 by flat washer 72 and retaining ring 74. Each wheel drive 68 further includes one spring loaded driven member or pin 80 slidably received in a cavity 82 formed in wheel hub 70. Wheel hub 70 may be an integrally-formed part of ground engaging wheel 30, as shown in FIGS. 3 and 5, or may be a separate element and include a plurality of bores (not shown) for receipt of bolts to attach a ground engaging wheel 30 to each wheel hub 70. Wheel hub 70 is not rotatably fixed to axle 38 and may be overdriven in the forward direction relative to the driven axle, or rotated in the reverse direction with the axle when the cone clutches in transmission 40 are disengaged.

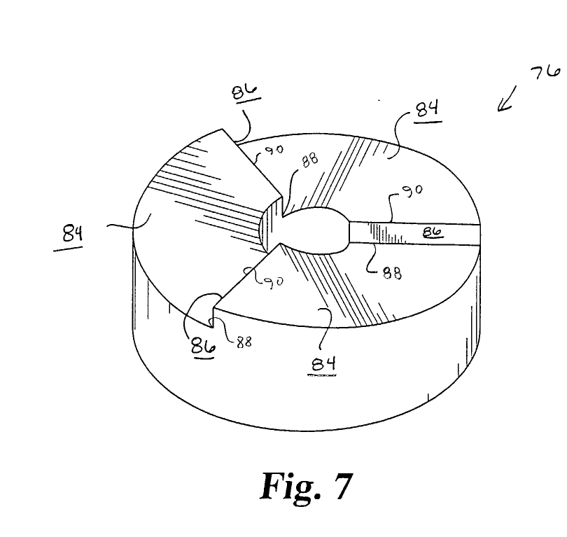

Wheel drive 68 further includes ratchet member 76 which is secured to axle 38 by pin 78 extending through ratchet member 76 and axle 38. Ratchet member 76 is thus rotatably and axially fixed to axle 38. With reference to FIGS. 6 and 7, ratchet member 76 has a plurality of ramps 84 equally spaced about its axially outward face. Engaged with this face of the ratchet member is spring-loaded pin 80 slidably disposed in its cavity 82. Spring 94 biases driven member 80 in a direction parallel with rotational axis 92 of axle 38, and urges the tip of the pin into engagement with a ramp surface 84 of ratchet member 76.

In operation, when the trimmer is propelled forward, the end of each spring-loaded pin 80 is located in a corner defined by a corresponding ramp surface 84 and a radially-extending flat driving surface 86. Each driving surface 86 has opposite first and second edges 88, 90, respectively, between which surface 86 extends in a direction parallel with rotational axis 92 of axle 38. Each ramp 84 extends between circumferentially adjacent first and second edges 88 and 90, as best shown in FIG. 7. The abutment of pins 80 and surfaces 86 engages ratchet members 76 and wheel hubs 70 such that the rotational movement of ratchet members 76 is transmitted to wheel hubs 70 and thus to ground engaging wheels 30 by driving surfaces 86 pushing pins 80, that is, placing pins 80 in shear, to cause wheel hubs 70 and wheels 30 to rotate in a forward direction.

When the trimmer 20 is to be moved in reverse, the cone clutches within transmission 40 are disengaged, preventing transmission 40 from driving axle 38. Each pin 80 and a driving surface 86 again abut one another; however, when trimmer 20 is moving in a reverse direction, wheels 30 and wheel hubs 70 rotate, causing pins 80 to push against surfaces 86 in turn causing ratchet members 76 and axle 38 to rotate in a reverse direction. It is to be noted that such reverse movement can only occur when the cone clutches are disengaged as the associated worm and worm gear prevent reverse rotation of axle 38 when the cone clutches are engaged, as those skilled in the art and familiar with the Model 301 transmission would be aware.

When trimmer 20 is steered through a turn, the wheel 30 at the outside of the turn is overdriven by the operator pushing on that side of the handle, and rotates faster than the wheel 30 at the inside of the turn. In such a condition, at the outside wheel 30, pin 80 begins to slide away from driving surface 86 of its respective ratchet member and along its ramp 84 and into cavity 82 of the associated hub as that wheel 30 is being overdriven. Pin 80 may continue sliding along ramp 84 until reaching the end thereof, at which point pin 80 is urged by the spring into the next corner defined by another driving surface 86 and ramp 84. If the overdriven condition continues, pin 80 may continue sliding along that ramp 84 in a similar manner. At the wheel 30 at the inside of the turn, pin 80 and its respective surface 86 remain in an abutting relationship without any movement of pin 80 along ramp 84. When the turn is complete, pin 80, associated with the wheel 30 at the outside of the turn, returns to a position wherein pin 80 abuts driving surface 86 and operation of trimmer 20 continues as described above, both wheels 30 being propelled by the transmission.

While this invention has been described as having an exemplary structure, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A walk-behind string trimmer comprising:
a frame;
an engine mounted on said frame;
a rotary cutter carried by said frame and selectively engaged with said engine;
a pair of ground engaging wheels;
a transmission mounted by said frame and engaged with said engine, said transmission having an output shaft; and
a steering mechanism having a ratchet member driven by said output shaft, wherein said ground engaging wheels are selectively drivingly coupled to said transmission through said ratchet member.

2. The walk-behind trimmer of claim 1 further comprising an axle rotatably supported by the frame.

3. The walk behind trimmer of claim 2 further comprising an axle driving mechanism including:
a first sprocket rotatably attached to said transmission output shaft;
a second sprocket rotatably attached to said axle; and
a chain engaging said first sprocket and said second sprocket, wherein said axle is driven through said chain.

4. The walk behind trimmer of claim 1, wherein said steering mechanism further comprises a wheel hub selectively drivingly coupled to said ratchet member.

5. The walk-behind string trimmer of claim 1, wherein said ratchet member includes a plurality of ramps thereon with a corresponding number of radially extending surfaces, one said radially extending surface associated with one said ramp.

6. The walk-behind string trimmer of claim 5, wherein said wheel hub includes at least one pin retained therein, said pin abutting one said radially extending surface to couple said ratchet member and said wheel hub.

7. The walk-behind string trimmer of claim 6, wherein when said ratchet member and said wheel hub are coupled and said transmission output shaft is coupled to said transmission input shaft, said axle drives said ground engaging wheels in a forward direction.

8. The walk-behind string trimmer of claim 6, wherein when said ratchet member and said wheel hub are coupled and said transmission output shaft is not coupled to said transmission input shaft, said ground engaging wheels drive said axle in a reverse direction.

9. A walk-behind trimmer comprising:
an engine having an output shaft;
a cutter engaged with said engine output shaft;
a transmission having an input shaft and an output shaft coupled to said input shaft, said transmission input shaft being engaged with said engine output shaft;
an axle rotatably coupled to said transmission output shaft and having opposite ends;
a ground-engaging wheel disposed at each said end of said axle, each said wheel being nonrotatably fixed to said axle;
a ratchet member affixed to one of each said axle end and each said ground-engaging wheel, each said ratchet member having at least one driving surface having opposite first and second edges between which said driving surface extends in a direction parallel to the axis of rotation of said axle, and at least one ramp surface which extends between circumferentially adjacent first and second driving surface edges;
a driven member coupled to the other of each said axle and each said ground-engaging wheel, said driven member being urged into engagement with a said ramp surface, said driven member and said driving surface having an engaged condition wherein they are in contact and the respective said ground-engaging wheel is driven by said axle, and an overdriven condition wherein they are separating and the respective said ground-engaging wheel is being rotated faster than said axle.

10. The walk-behind trimmer of claim 9, wherein said cutter is in selective engagement with said engine output shaft.

11. The walk-behind trimmer of claim 9, wherein said transmission input and output shafts are selectively coupled.

12. The walk-behind trimmer of claim 9, wherein said transmission input shaft is in selective engagement with said engine output shaft.

13. The walk-behind trimmer of claim 9, wherein a said ratchet member is rotationally and axially affixed to each end of said axle, and a said driven member is coupled to each said ground-engaging wheel.

14. The walk-behind trimmer of claim 9, wherein each said ratchet member is provided with three said driving surfaces and three said ramp surfaces.

15. The walk-behind trimmer of claim 14, wherein said driven member is an elongate pin, the tip of which bears against a said ramp surface.

16. The walk-behind trimmer of claim 9, wherein said axle and said transmission output shaft rotate relative to each other at a fixed drive ratio.

17. The walk-behind trimmer of claim 16, wherein said transmission has a housing and said transmission output shaft extends through said transmission housing, and further comprising a sprocket and chain mechanism consisting of a first sprocket affixed to said transmission output shaft, a second sprocket substantially aligned with said first sprocket and affixed to said axle, and a chain engaging said first and second sprockets, whereby said transmission and said axle are in driving communication solely through said sprocket and chain mechanism.

18. The walk-behind trimmer of claim 17, wherein said sprocket and chain mechanism is located along said transmission output shaft on either side of said transmission housing.

19. A walk-behind trimmer comprising:
a frame;
an operator-controlled handle attached to the frame;
an engine mounted to said frame, said engine having an output shaft;
a rotary cutter attached to said frame, said cutter having an axis of rotation substantially parallel with and located forward of said engine output shaft, said cutter being operatively engaged with said engine output shaft;
a transmission having an input shaft substantially parallel with said engine output shaft, said transmission input shaft being operatively engaged with said engine output shaft, said transmission having a housing and a solid output shaft extending through said housing and having opposite ends supported by said frame, said transmission input and output shafts being engaged within said housing;
a solid axle supported by said frame and substantially parallel with said transmission output shaft;
means for rotatably coupling said transmission output shaft and said axle within a single plane substantially perpendicular to said axle said transmission output shaft, and at a constant drive ratio at which said axle is driven at a speed which is less than the speed of said transmission output shaft;
a pair of ground-engaging wheels rotatably mounted at opposite ends of said axle; and
means for allowing one of said ground-engaging wheels to rotate independently of the other said ground-engaging wheel in a forward direction at a speed faster than the speed of said axle, and for preventing said axle from rotating at a speed faster than the speed of either of said ground-engaging wheels in the forward direction, whereby said trimmer may be self-propelled but easily steered during operation.

20. The walk-behind trimmer of claim 19, wherein said transmission input and output shafts are selectively engaged within said housing;
